(19) United States
(12) Patent Application Publication
(10) Pub. No.: US 2018/0308160 A1
(43) Pub. Date: Oct. 25, 2018

(54) RISK ASSESSMENT METHOD AND SYSTEM

(71) Applicant: Tencent Technology (Shenzhen) Company Limited, Shenzhen (CN)

(72) Inventor: Jiang LIU, Shenzhen (CN)

(21) Appl. No.: 16/024,159

(22) Filed: Jun. 29, 2018

Related U.S. Application Data
(63) Continuation-in-part of application No. PCT/CN2017/071920, filed on Jan. 20, 2017.

(30) Foreign Application Priority Data
Feb. 1, 2016 (CN) 201610070616.5

(51) Int. Cl. G06Q 40/02

(52) U.S. Cl. CPC G06Q 40/025

(57) ABSTRACT

A risk assessment method and computing device are provided. Valuable weak variables are added to a risk assessment model, making risk assessment process more comprehensive and more stable, helping to improve the accuracy and objectiveness of risk assessment. In some implementations, the method includes: categorizing a plurality of groups of variables into a first category of variable groups and a second category of variable groups in accordance with correlations between respective groups of variables and a target variable; obtaining a plurality of risk assessment sub-models for respective groups of variables in the second category; obtaining a plurality of sub-model results for the respective risk assessment sub-models in the second category; and obtaining a comprehensive risk assessment model for evaluating the risk of the target variable based on (1) a plurality of variables in the first category and (2) the plurality of sub-model variables in the second category.

### PRIORITY CLAIM AND RELATED APPLICATION

This application is a continuation-in-part application of PCT/CN2017/071920, entitled “RISK ASSESSMENT METHOD AND SYSTEM” filed on Jan. 20, 2017, which claims priority to Chinese Patent Application No. 201610070616.5, entitled “RISK ASSESSMENT METHOD AND SYSTEM” filed with the Chinese Patent Office on Feb. 1, 2016, all of which are incorporated herein by reference in their entirety.

### FIELD OF THE TECHNOLOGY

The present disclosure relates to the field of risk assessment technologies based on computer technologies, and specifically, to a risk assessment method and system.

### BACKGROUND OF THE DISCLOSURE

Risk assessment is assessment on the possibility of risks that may be brought by projected situations and/or recognized threats, such as evaluation of impact caused by threats and/or weakness of certain information. There are two common risk assessment methods: a model method and an expert method.

The model method is a method for constructing a risk assessment model using a machine learning method such as logistic regression, a decision tree, and a random forest, and performing risk assessment based on a model result. The practice shows that some weak variables may be quite significant in services. However, in the model method, the weak variables cannot be selected for a model. Consequently, in the model method, functions of some variables cannot be reflected, and it is difficult to reflect the future trend of service development.

The expert method is a method for performing risk assessment by determining considerations of the assessment according to opinions of an expert. The expert method can resolve the problem that the weak variables cannot be selected for the model. However, the expert method is a relatively subjective method, in which the value of data is not fully dug and used.

### SUMMARY

Embodiments of the present disclosure provide a risk assessment method. Valuable weak variables are dug and added to a risk assessment model, making the risk assessment process more comprehensive and the interpretability and stability stronger, helping to improve the accuracy of risk assessment, and ensuring the objectiveness of risk assessment.

A first aspect of the present disclosure provides a risk assessment method, including: obtaining a plurality of groups of variables from a plurality of variables associated with a user in accordance with data sources of respective variables, wherein the plurality of variables are used for assessing a risk of a target variable associated with the user; categorizing the plurality of groups of variables into a first category of variable groups and a second category of variable groups in accordance with correlations between respective groups of variables and the target variable, wherein each group of variables in the first category of variable groups has a higher correlation than each group of variables in the second category of variable groups; obtaining a plurality of risk assessment sub-models for respective groups of variables in the second category of variable groups, wherein a risk assessment sub-model for a respective group of variables is associated with correlation coefficients of the respective variables in the respective group; obtaining a plurality of sub-model results for the respective risk assessment sub-models in the second category of variable groups, wherein each sub-model result in a sub-model variable; and obtaining a comprehensive risk assessment model for evaluating the risk of the target variable based on (1) a plurality of variables in the first category of variable groups and (2) the plurality of sub-model variables in the second category of variable groups.

A second aspect of the present disclosure provides a risk assessment computing device having one or more processors and memory storing a plurality of programs, wherein the plurality of programs, when executed by the one or more processors, cause the risk assessment computing device to perform the aforementioned risk assessment method.

A third aspect of the present disclosure provides a non-transitory computer readable storage medium storing a plurality of programs in connection with a risk assessment computing device having one or more processors, the risk assessment computing device being applied to a risk assessment system, wherein the plurality of programs, when executed by the one or more processors, cause the risk assessment computing device to perform the afore mentioned risk assessment method.

It can be learned from the above that in some embodiments of the present disclosure, a technical solution is used in which variables are grouped, and then categorized to obtain two categories of variable groups. Risk assessment sub-models are obtained for respective groups of variables in the second category, and model results are used as respective variables together with variables in the first category, to form a third category of variables, and finally, a comprehensive risk assessment model are obtained based on the third category of variables to assess a risk of a target variable.

The method fully digs and uses the value of the data from the second category of variable groups (e.g., the weak variable groups), so that the second category of variable groups are taken into consideration when performing risk assessment of a target variable (e.g., the risk of a user defaults on a loan) using a finally constructed comprehensive risk assessment model. Such comprehensive risk assessment uses sub-model variables derived from the variable groups in the second category of variable groups, and variables from the first category of variable groups (e.g., the strong variable groups). Therefore, the risk assessment process is more comprehensive, the interpretability and the model stability are stronger, and the model result is more objective, more accurate, and more robust in application, thereby helping to improve the effectiveness of risk assessment, which reflects the future trend of service development.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following descriptions show only some embodiments of the present disclosure, and a person of ordinary skill in the art may still derive other drawings from these accompanying drawings without creative efforts.

FIG. 1 is a schematic flowchart of a risk assessment method according to an embodiment of the present disclosure;

FIG. 2 is a schematic diagram of a process of constructing a model by using a conventional model method;

FIG. 3 is a schematic diagram of a process of constructing a model by using the risk assessment method in the embodiment of the present disclosure;

FIG. 4 is a schematic structural diagram of a risk assessment system according to an embodiment of the present disclosure; and

FIG. 5 is a schematic structural diagram of a risk assessment computing device according to an embodiment of the present disclosure.

### DESCRIPTION OF EMBODIMENTS

To make the solutions of the present disclosure more comprehensible for a person skilled in the art, the following describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative effects shall fall within the protection scope of the present disclosure.

The technical solutions in the embodiments of the present disclosure relate to a risk assessment method based on a risk assessment computing device. The following first briefly describes some terms used in the risk assessment method.

Throughout this specification, the term “risk scorecard” (e.g., a credit scorecard) refers to a risk assessment model, for example, a risk assessment model used for assessing credit risks of users (e.g., a quantitative estimate of the probability that a user will display a certain behavior, e.g., loan default, bankruptcy, or a lower level of delinquency). A risk scorecard usually includes two types: supervised learning and semi-supervised learning (if reject inference exists). Usually, a supervised target (that is, a target variable) is that whether a user defaults in a period of time, for example, if the user does not pay back loans in time, e.g., whether the loans are more than 90 days overdue within six months after the loans are issued. Usually, there are two methods for constructing a risk scorecard: a model method and an expert method.

The term “weak variable” refers to a variable that is statistically not significant enough, that is, a probability (P-Value, probability, Pr) in a significance hypothesis test is greater than or equal to a pre-set standard, for example, 0.05, and that cannot be selected for a risk assessment model according to such a statistics standard. Comparatively, the term “strong variable” refers to a variable that is statistically significant, that is, a P-value in a significance hypothesis test is less than a pre-set standard, for example, 0.05, and that can meet a significance statistics standard. It should be noted that the pre-set standard may alternatively be a value different from 0.05, for example, 0.01. This is not limited in this specification. It should be noted that the hypothesis test is an important element in inferential statistics. When the hypothesis test is performed by using professional statistics software, the P-value is a basis for test decision. The P-value is a probability, and reflects a possibility that an event happens. In statistics, usually, a P-value obtained by using a significance test method may indicate a significant variable when P<0.05, which means that a probability of a difference between samples caused by a sampling error is less than 0.05.

The term “variable group” refers to a group of variables from a same data source. The term “strong variable group” refers to a variable group having a relatively high correlation with a target variable and/or having a relatively high correlation with user information. The term “weak variable group” refers to a variable group having a relatively low correlation with a target variable and/or having a relatively low correlation with user information. The correlation may be represented by using a correlation coefficient such as a P-value. An average value of P-values of all variables in a variable group may be calculated. When the average value is greater than a threshold, it is considered that the variable group has a relatively high correlation with the target variable; when the average value is not greater than the threshold, it is considered that the variable group has a relatively low correlation with the target variable.

The term “expert scorecard” refers to a risk scorecard designed based on the industry expert experience. An expert scoring method is a risk assessment method performed based on the expert scorecard.

The term “logistic regression (LR)” refers to a method that is maturely and widely applied at present and that is used for developing a risk scorecard, and is a generalized linear regression method.

The term “decision tree” refers to a method for approximating a value of a discrete function. The decision tree is a typical classification method, and may also be used for constructing a prediction model. First, data is processed, and a readable rule and decision tree are generated by using an inductive algorithm. Then, the decision tree is used for analyzing new data. Substantially, the decision tree is a process of classifying data according to a series of rules. Typical algorithms of the decision tree include ID3, C4.5, a classification and regression tree (CART), and the like.

The term “analytic hierarchy process” refers to a decision method of determining an element that is always related to a decision as a target, criterion, solution, or the like in a hierarchy, and performing qualitative and quantitative analysis based on the hierarchy.

The term “variable normalization” refers to an operation of standardizing a variable, an objective of which is to make a variable having different dimensions comparable. There are different normalization methods. In this specification, a minimum-maximum normalization method may be used, and a value range of each processed variable is [0,1].

The term “model robustness” refers to stability of a model from a development process to an implementation process. A model having higher robustness has a more ideal implementation effect.

The term “Kolmogorov Smirnov (KS)” refers to a common metric for measuring an effect of a score model. Kolmogorov and Smirnov are names of two Soviet mathematicians. KS is in a range of 0 to 100, and a larger value indicates a better model effect. Usually, KS being equal to approximately 25 is a risk assessment criterion acceptable by financial institutions.

The following briefly describes the model method.

The model method is a most common risk assessment method. A risk assessment model (a logic model) constructed by using the model method may be referred to as a risk scorecard. There are many conventional methods for constructing a risk scorecard, for example, a logistic regression method, a decision tree, and a random forest. The logistic/stepwise regression method is one of most widely and maturely applied methods at present. The following uses the logistic regression method as an example to describe a basic modeling process of the risk scorecard. The process includes the following steps:

First, a normalized modeling wide table, for example, Table 1, is prepared. Usually, there are more than hundreds of variables x in Table 1. It is assumed that there are totally 10000 user samples and 300 attributes (e.g., variables) in Table 1. Table 1 includes a total of three types of variables from different data sources: payment variables, instant messaging variables, and social networking variables. Assuming that the three types of variables each include 100 variables, there are a total of 300 variables. Yin the second column in Table 1 is a supervised target or a target variable, which may specifically refer to whether a user does not pay back loans in time, e.g., whether the loans are more than 90 days overdue within one year after the loans are issued. A value of each variable in the table is a normalized value. Therefore, each value is in a range of [0,1].

It should be noted that each variable in the embodiments of the present disclosure is from a legal data source, for example, including user data or data that can be queried for by the public. The user data is data that is authorized by users to be published or shared for use.

TABLE 1
Modeling wide table

| User | Target | Variable | | Variable | Variable | | Variable | | Variable |
|---|---|---|---|---|---|---|---|---|---|
| number | variable | 1 | . . . | 15 | 16 | . . . | 30 | . . . | 300 |
| obs | target(y) | x1 | . . . | x15 | x16 | . . . | x30 | . . . | x300 |
| 1 | 1 | 0 | . . . | 0 | 1 | . . . | 0.8 | . . . | 0.50 |
| 2 | 0 | 1 | . . . | 0.12 | 0 | . . . | 0.2 | . . . | 0.45 |
| 3 | 0 | 1 | . . . | 0.27 | 1 | . . . | 0.1 | . . . | 0.31 |
| 4 | 0 | 0 | . . . | 0.87 | 0 | . . . | 0.3 | . . . | 0.12 |
| . . . | . . . | . . . | . . . | . . . | . . . | . . . | . . . | . . . | . . . |
| 10000 | 1 | 1 | . . . | 0.35 | 0 | . . . | 0.9 | . . . | 0.53 |

It is easily understood that among the three types of variables, payment variables are directly correlated and have a relatively high correlation with finance, and may be considered as a strong variable group; instant messaging variables and social networking variables each have a relatively low correlation with finance and may be considered as a weak variable group.

It is assumed that in Table 1, the first to the fifteenth variables are strong variables in the strong variable group, and the sixteenth to the thirtieth variables are strong variables in the weak variable group. After a series of variable analysis and variable screening, a normal result may be that the first 15 strong variables in the strong variable group and the sixteenth to the eighteenth strong variables in the weak variable group are considered in a final logistic regression model. A result of the obtained logistic regression model is shown in formulas (1) and (2):

$$\begin{matrix}Logodds = f ( x ) = {a}_{0} + {\sum }_{i = 1}^{18} {a}_{i} {x}_{i} & ( 1 ) \\ Probability = exp ( {Logodds}_{15} ) / ( 1 + exp ( {Logodds}_{15} ) ) & ( 2 )\end{matrix}$$

Log odds being an output result of the logistic regression model (model result for short), Probability being a probability parameter, and Probability representing a probability that the model result Log odds is impaired.

It can be learned that in the weak variable group, only 3 variables including ×16, ×17, and ×18 are selected for the model, and the remaining variables in the weak variable group do not enter the model. Although other strong variables (for example, ×19 to ×30) in the weak variable group can be placed into the model by lowering a selection standard (e.g., a select in/out screening criterion) or manually selected in (e.g., forced—in method) the model, contributions of these variables (e.g., ×19 to ×30) from the weak variable group to the model cannot be effectively reflected, or a weight of the weak variable group in the risk scorecard is excessively low. Such an approach further has a significant disadvantage: variables in the weak variable group that are newly selected in the model by lowering the selection criterion may be very unstable.

The following briefly describes the expert method.

An expert scorecard is a logistic score model designed and formed based on the industry expert experience. The expert scorecard is very useful at an initial stage of the service development, and is also frequently used in some public services relating to a relatively small number of users. For a conventional expert scorecard, opinions of experts are collected in advance, considerations, that is, ranges of used variables, for scoring are determined, and then a weight of each variable is determined, so as to finally obtain an expert scorecard required for a service. Data and variable assumption are the same as those in Table 1 in the model method. The expert scorecard is shown in Table 2.

TABLE 2
Expert scorecard

| | Variable | | | | | | |
|---|---|---|---|---|---|---|---|
| Expert | Variable | | Variable | Variable | | Variable | |
| Weight | 1 | . . . | 15 | 16 | . . . | 30 | Total |
| expert | x1 | . . . | x15 | x16 | . . . | x30 | total |
| 1 | 20 | . . . | 10 | 5 | . . . | 1 | 100 |
| 2 | 15 | . . . | 8 | 5 | . . . | 2 | 100 |
| 3 | 10 | . . . | 11 | 6 | . . . | 2 | 100 |
| 4 | 30 | . . . | 6 | 4 | . . . | 2 | 100 |
| 5 | 25 | . . . | 7 | 2 | . . . | 1 | 100 |
| Average | 20 | . . . | 8 | 4 | . . . | 2 | 100 |
| weight | | | | | | | |

The expert scorecard resolves a problem that most variables in the weak variable group cannot be selected for the model in the model method, and is relatively easy to understand and implement. However, the expert scorecard has a fatal defect: The value of data is not fully dug and used, having relatively strong subjectivity. For example, the method does not consider correlations and synergies among the variables, and a variable value may vary relatively greatly, causing a model to be not very stable.

As described above, the existing risk scorecard construction methods mainly include the expert method and the model method. Both of the two methods are relatively mature in industry application, but their defects are also very obvious. The main defect of the model method is that a weak variable cannot be selected, and a service development trend cannot be reflected. The main defect of the expert method is that the method has relatively strong subjectivity and cannot dig and use the value of data to the greatest extent.

Therefore, the embodiments of the present disclosure provide a risk assessment method and system. The following provides descriptions separately.

### Embodiment 1

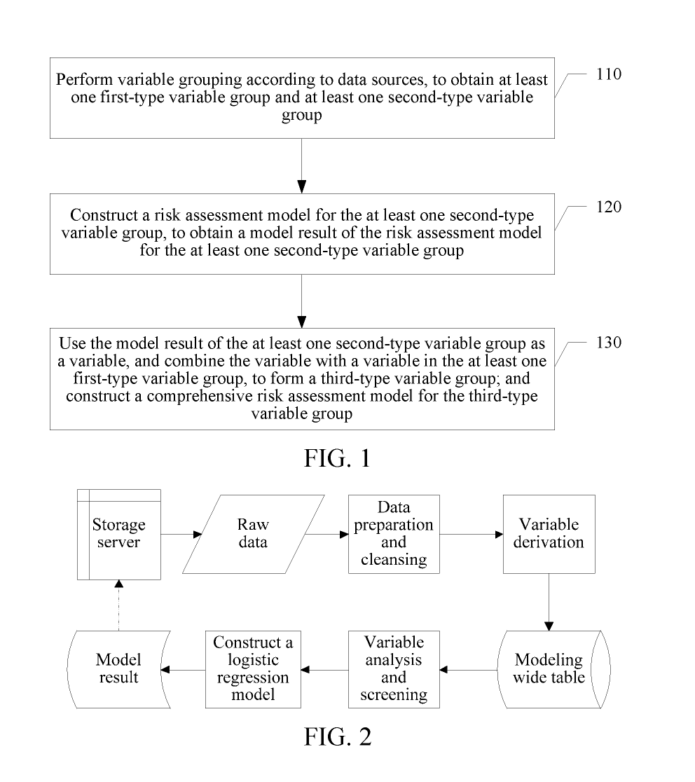

Referring to FIG. 1, the first embodiment of the present disclosure provides a risk assessment method. The method may include the following steps:

S110: Perform variable grouping according to data sources, to obtain at least one first-type variable group and at least one second-type variable group.

With the rapid development of the Internet, there are increasingly more information and data, and data sources used in the risk assessment method are increasingly more widely distributed. Some data are relatively strongly correlated with a credit risk, and some data are relatively weakly correlated with the credit risk. In this specification, first, variables are grouped according to the data sources, and variables that are from a same source are considered as one variable group. For example, three types of variables respectively from payment, instant messaging, and social networking may be considered as three variable groups. In some embodiments, the method includes obtaining a plurality of groups of variables from a plurality of variables associated with a user in accordance with data sources of respective variables. In some embodiments, the plurality of variables are used for assessing a risk of a target variable associated with the user (e.g., a chance that the user will default on the loan). In some embodiments, the data source may be related to software applications, or platforms running on a software application. For example, a respective group of variables includes a plurality of variables from a software application (e.g., a social networking application), or a certain platform in a software application, e.g., a payment platform, a travel booking platform, an online shopping platform, or a third-party developed platform that operates in the application.

In some embodiments, the variable groups are then categorized (also referred to “classified”) into a first category of variable groups, e.g., including strong variable groups, and a second category of variable groups, e.g., including weak variable groups. In some embodiments, the categorization is performed in accordance with correlations between respective groups of variables and the target variable. In some embodiments, each group of variables in the first category of variable groups has a higher correlation (e.g., a higher correlation score) than each group of variables in the second category of variable groups. In some embodiments, correlation scores of respective variables within the group are determined by the system or by the user (e.g., automatically assigned by the system based on historical correlation scores of the same type of variables, or manually selected by the user). In some embodiments, an average correlation score of a group can be calculated using correlation scores of respective variables within the group. In some embodiments, a correlation score of a respective variable is associated with (e.g., quantitatively representing) a correlation between the respective variable and the target variable. In some embodiments when determining whether respective variables in each group are strong or weak variables, standards can be different among different groups according to group characteristics. For example, a standard of 0.1 can be used for variables from a payment app (e.g., correlation score or coefficient greater than 0.1 indicates strong variables, whereas correlation score lower than 0.1 indicates weak variables), 0.05 may be used for variables from an instant messaging app (e.g., QQ), and 0.06 may be used for a social networking app (e.g., WeChat). In some embodiments, the standards may be determined based on whether a certain app has more financial features, or the user uses financial features within an app (e.g., WeChat) more often than the financial features of another app (e.g., QQ). As discussed earlier, for each group, variables with correlation coefficients above the group standard are strong variables in this group, whereas variables with correlation coefficients below the group standard are weak variables in this group. In some embodiments, there are strong variables in a weak group of variables, and there are weak variables in a strong group of variables.

In some embodiments, some variables related to financial management, saving, consumption, and payment of users are directly correlated with user information (especially financial information) such as funds, and have relatively strong correlations with credit risks of the users. For example, the variable groups including these variables may be referred to as the strong variable groups. Some variables from variable groups such as instant messaging, social networking, and gaming are not directly correlated with finance, only reflect some social and behavior habits of users, and therefore have relatively weak correlations with credit risks. For example, the groups including these variables may be referred to as the weak variable group.

Factors of categorizing the variable groups may include, but are not limited to, the following:

1. Correlations between the data sources and a target variable (for example, whether there is a default on the loan).

Usually, a Pearson correlation coefficient may be used in correlation analysis, and a calculation method thereof is not described herein. Usually, a correlation criterion may be: a value above 0.6 indicates a strong correlation, 0.4 to 0.6 indicates a medium correlation, 0.2 to 0.4 indicates a weak correlation, and a value below 0.2 indicates an extremely weak correlation or no correlation. However, a criterion for actual application in the financial circle is far from that, and the correlation criterion is much lower, because a variable whose correlation coefficient is above 0.4 is extremely rare. That is, the correlation criterion may be defined according to a requirement. For example, for a payment variable, it may be defined that a value above 0.1 indicates a strong correlation, and a value below 0.1 indicates a weak correlation.

2. Correlations between the data sources and user information (for example, funds information or other types of financial information of the user).

Correlations are also quite related to variable types. Usually, correlations of variables such as loans, financing, and payment that are relatively close to information such as user funds is relatively strong; correlations of variables such as instant messaging or social networking that is relatively far from the user funds is relatively weak. During application, an importance value may be used for representing the correlations between the data sources and the user information, for example, strong, medium, and weak.

In this specification, the variable groups may be classified into the strong variable group and the weak variable group according to the foregoing two criteria, that is, the correlations between the data sources and the target variable and/or the correlations between the data sources and the user information. The strong variable group is the first category of variable groups, and the weak variable group is the second category of variable groups.

In some embodiments, a specific method for classifying the variable groups may include the following steps:

a0: Group all variables into a plurality of variable groups according to different data sources.

a1: Calculate correlation coefficients of respective variables based on correlations between the data sources of the respective variables and the target variable, and calculate average correlation coefficients for respective groups of variables based on the correlation coefficients of the variables from the respective groups of variables. In some embodiments, the correlation coefficient is the P-value described above.

a2: Determine importance values of respective groups of variables according to correlations between the data sources of the variables within the respective groups of variables and the user information.

a3: Perform variable group classification/categprozatopm according to the average correlation coefficients and/or the importance values of the plurality of variable groups, wherein a variable group whose average correlation coefficient is greater than a threshold and/or whose importance value is higher is determined to be a first category of variable groups, e.g., a strong category (e.g., type) of variable groups. Other variable groups having average correlation coefficient lower than the threshold and/or lower importance value are determined to be in a second category of variable groups, e.g., weak type variable groups. In some embodiments, the plurality of groups of variables are categorized according to the average correlation coefficients and the importance values of the plurality of groups of variable. In some embodiments, the plurality of groups of variables in the first category of variable groups have respective average correlation coefficients that are greater than a predetermined first threshold and respective importance values that are higher than a predetermined second threshold. The plurality of groups of variables in the second category of variable groups have respective average correlation coefficients that are less than or equal to the predetermined first threshold and respective importance values that are lower than or equal to the predetermined second threshold.

It can be learned that the strong variable group is a variable group having a relatively high correlation with the target variable and/or having a relatively high correlation with the user information, and the weak variable group is a variable group having a relatively low correlation with the target variable and/or having a relatively low correlation with the user information.

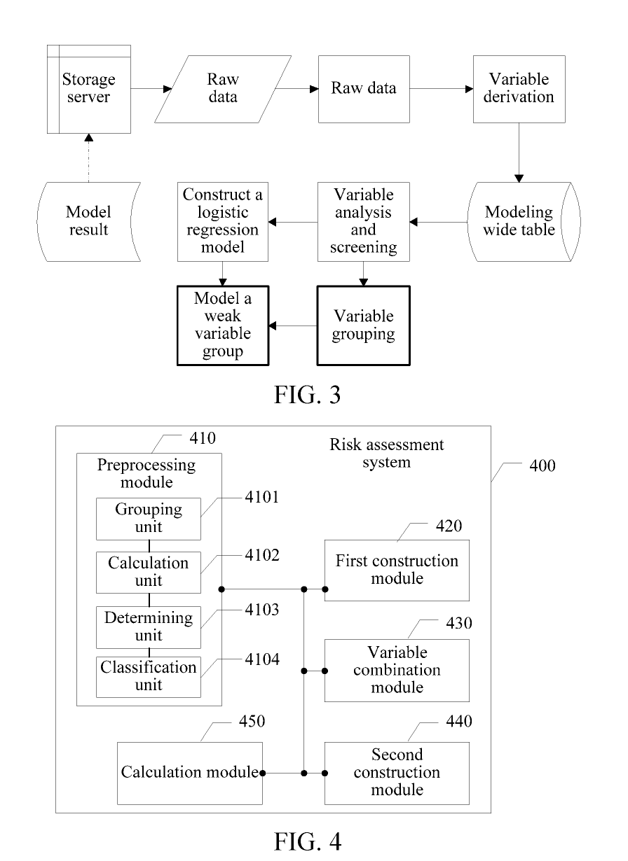

As shown in FIG. 3, FIG. 3 is a schematic diagram of variable group categorization in an example of an application scenario. Correlation criteria for various types of variables are also different. Correlation criterion thresholds set in combination with practical experience may be: 0.1 for payment variables from a payment app, 0.05 for instant messaging variables from an instant messaging app, and 0.06 for social networking variables from a social networking app. A variable whose correlation is greater than the threshold is considered as a strong variable, and a variable whose correlation is less than the threshold is considered as a weak variable. In some embodiments, among payment variables, relatively strong variables include credit card payment reflecting a payment capability of a user, a fund size reflecting a payment capability of a user, and the like, and relatively weak variables include a user transaction frequency, a phone card recharge of a user, and the like. Among instant messaging variables, relatively strong variables include the number of commonly-used login cities reflecting user stability and the like, and relatively weak variables include the number of pieces of sent and received information and the like. Among social networking variables, relatively strong variables include the number of and the quality of relatively close friends (e.g., a number of friends who have good personal credit history and/or low risk of loan default and similarities between the user and such types of high quality friends), and relatively weak variables include the number of friends (e.g., a number of friends who have bad credit history and/or high risk of loan default and similarities between the user and the such types of low quality friends), the amount of sent and received information, and the like.

For convenience of description, variable names of the three types of variables are corresponding to those in Table 1. Specifically, refer to the third row and the fourth row in Table 3. According to the correlation criterion thresholds of the variables described above, the numbers of strong variables and weak variables in each type of variables are respectively: 15 and 85 for payment variables, 8 and 92 for instant messaging variables, and 7 and 93 for social networking variables.

TABLE 3
Variable grouping

| | Variable type | | | | | |
|---|---|---|---|---|---|---|
| | Payment (A) | | Instant messaging (B) | | Social networking (C) | |
| | Correlation | | | | | |
| | Relatively | Relatively | Relatively | Relatively | Relatively | Relatively |
| | strong | weak | strong | weak | strong | weak |
| Variable | xA1-xA15 | xA16-xA100 | xB1-xB10 | xB11-xB100 | xC1-xC10 | xC11-xC100 |
| Variable name | x1-x15 | x31-x115 | x16-x23 | x116-x207 | x24-x30 | x208-x300 |
| Number of | 15 | 85 | 8 | 92 | 7 | 93 |
| variables | | | | | | |
| Correlation | ≥0.1 | <0.1 | ≥0.05 | <0.05 | ≥0.06 | <0.06 |
| coefficient | | | | | | |

| | | | |
|---|---|---|---|
| Average | 0.12 | 0.03 | 0.02 |
| correlation | | | |
| coefficient | | | |
| Importance value | Strong | Weak | Weak |
| Variable grouping | Weak variable group | Weak variable group | Weak variable group |

It can be learned from Table 3 that three types of variables from payment, instant messaging, and social networking may be classified into three groups according to different data sources (e.g., apps, platforms), that is, variable groups A, B, and C. An average correlation coefficient and an importance value of the variable group A are the largest. Therefore, the variable group A is a strong variable group, and the variable group B and C are weak variable groups.

It should be noted that the weak variable groups are different from weak variables. A weak variable group may also include a strong variable, but a correlation of between the group and a target variable is merely not very strong. Similarly, a strong variable group may also include a weak variable. Certainly, a weak variable is more likely to be included in a weak variable group, and a strong variable is more likely to be included in a strong variable group. Although many variables in a weak variable group are significant in statistics, when they are placed together with a strong variable group for modeling, usually, only a small part of them can enter the model. The effect of the weak variable group is greatly diluted, and the weak variable group cannot play a due role.

S120: Construct a risk assessment sub-model for the at least one second category of variable groups, to obtain a sub-model result of the risk assessment sub-model for the second category of variable groups. A risk assessment sub-model is established for each of the at least one variable group in the second category, or the weak variable group, obtained in the foregoing step, to obtain a model result of the risk assessment model for each weak variable group.

In this step, a plurality of risk assessment sub-models are obtained for respective groups of variables in the second category of variable groups (or the weak variable groups). A risk assessment sub-model for a respective group of variables is associated with correlation coefficients of the respective variables in the respective group. In some embodiments, a plurality of sub-model results are obtained for the respective risk assessment sub-models in the second category of variable groups, wherein each sub-model result in a sub-model variable.

It is assumed that each weak variable group is modeled by using a logistic regression method. Considering the weak variable group, a variable selection criterion may be properly relaxed.

For example, a sub-model result of the weak variable group B corresponding to instant messaging is as follows:

$${Logodds}_{B} = f ( {x}_{B} ) = {a}_{0} + {\sum }_{i = 1}^{8} {a}_{i} {x}_{Bi} \qquad ( 3 )$$

In the formula (3), Log odds_{B} is a sub-model result (e.g., of the instant messaging variable group B), f(x_{B}) represents modeling of the variable group B, x_{Bi} represents the i^{th} variable in the variable group B, i is a positive integer, a₀ is an intercept term/a constant term, and aᵢ represents a weight of the variable x_{Bi}.

Considering a correspondence between variable names in Table 3, the formula (3) may be written as:

$${Logodds}_{B} = f ( {x}_{B} ) = {a}_{0} + {\sum }_{i = 16}^{23} {a}_{i} {x}_{i} \qquad ( 4 )$$

In the formula (4), Log odds_{B} is a sub-model result, f(x_{B}) represents modeling of the variable group B, a₀ is an intercept term/a constant term, aᵢ represents a weight of a variable xᵢ, and i is a positive integer.

Similarly, a modeling result of the weak variable group C corresponding to social networking may be obtained:

$${Logodds}_{C} = f ( {x}_{C} ) = {a}_{0} + {\sum }_{i = 1}^{7} {a}_{i} {x}_{Ci} \qquad ( 5 )$$

In the formula (5) Log odds_{C} is a sub-model result, f(x_{C}) represents modeling of the variable group C, x_{Ci} represents the i^{th} variable in the variable group C, i is a positive integer, a₀ is an intercept term/a constant term, and aᵢ represents a weight of the variable x_{Ci}.

Considering the correspondence between the variable names in Table 3, the formula (5) may be written as:

$${Logodds}_{C} = f ( {x}_{C} ) = {a}_{0} + {\sum }_{i = 24}^{30} {a}_{i} {x}_{i} \qquad ( 6 )$$

In the formula (6), Log odds_{C} is a sub-model result, f(x_{C}) represents modeling of the variable group C, a₀ is an intercept term/a constant term, aᵢ represents a weight of a variable xᵢ, and i is a positive integer.

It should be noted that risk assessment models represented by the foregoing formulas are merely examples, and are not intended to limit the present disclosure. In addition, when there are a plurality of variable groups in the second category, a risk assessment model may be established for only one of the variable groups in the second category, or a risk assessment model may be established for several or each of the variable groups in the second category. Both of them can have a corresponding technical effect, and the present disclosure imposes no limit thereon.

S130: Use the sub-model results of the variable group in the second category as a variable, and combine the variable with a variable in the at least one variable group in the first category, to form a third variable group; and construct a comprehensive risk assessment model for the third variable group. In some embodiments, a comprehensive risk assessment model for evaluating the risk of the target variable is obtained based on (1) a plurality of variables in the first category of variable groups and (2) the plurality of sub-model variables in the second category of variable groups. In some embodiments, a respective sub-model result is also a variable itself, because the result is expressed using the variables from the corresponding group of variables.

For example, in this step, a sub-model result of each weak variable group is used as a variable, and all variables in all strong variable groups are used together with all sub-model result variables, to form a third variable group. In this specification, the third variable group is also referred to as a combination variable group. It is assumed that a sub-model result of a risk assessment model for any weak variable group Xⱼ in the at least one weak variable group is denoted as Log oddsⱼ, Log oddsⱼ is used as a variable, and any variable in the at least one strong variable group is denoted as xᵢ. All variables Log oddsⱼ and xᵢ may be combined to form a combination variable group, both i and j being positive integers. The combination variable group may be represented by [x₁, x₂ . . . xᵢ . . . xₙ . . . Log oddsⱼ . . . Log oddsₘ], n being the number of variables xᵢ, m being the number of variables Log oddsⱼ, and both n and m being positive integers.

In this step, a comprehensive risk assessment model is constructed for the combination variable group:

$$Logodds = {a}_{0} + {\sum }_{i = 1}^{n} {a}_{i} {x}_{i} + {\sum }_{j = 1}^{m} {a}_{j} {Logodds}_{j} \qquad ( 7 )$$

a₀ being an intercept term/a constant term, aᵢ representing a weight of the variable xᵢ, and aⱼ being a weight of the variable Log oddsⱼ.

Assuming that there are two variables Log oddsⱼ, that is, Log odds_{B} and Log odds_{C} obtained in the foregoing step, the comprehensive model represented by the formula (7) may be written as:

$$Logodds = f ( {x}_{A} , {x}_{B} , {x}_{C} ) = f ( {x}_{A} , {Logodds}_{B} , {Logodds}_{C} ) = {a}_{0} + {\sum }_{i = 1}^{15} {a}_{i} {x}_{i} + {a}_{16} {Logodds}_{B} + {a}_{17} {Logodds}_{C} \qquad ( 8 )$$

Further, a probability parameter Probability may be calculated based on a sub-model result Log odds of the foregoing comprehensive model, and a formula is as follows:

Probability=exp(Log odds)/(1+exp(Log odds)) (9)

exp ( ) being an exponential function using a natural constant e as a base, and Probability representing a probability that the model result is impaired. Assuming that Probability is equal to 0.1 through calculation, it indicates that a probability that the model result is impaired is 10%.

It can be learned from the foregoing that according to the technical solution in this embodiment of the present disclosure, a problem in the existing technology is resolved methodologically:

(1) First, the variables are grouped and categorized according to the data sources, the correlations between the data sources and the target variable (for example, the financial risk), and the correlations between the data sources and the user information (for example, the funds information), to obtain the strong variable group(s) and the weak variable group(s), for example, one strong variable group and two weak variable groups.

(2) The weak variable groups are sub-modeled separately, for example, two sub-models are constructed for the two weak variable groups.

(3) Sub-model results of the two weak variable groups are used as two variables, which are placed together with a variable in the strong variable group, to construct a final comprehensive risk assessment model.

According to this method, a relatively large number of variables in the weak variable groups may enter the model, ensuring contributions of the weak variable groups. In addition, the model has stronger interpretability in services, and has stronger robustness in practical application.

It should be noted that in this embodiment of the present disclosure, it is not necessarily that a risk assessment model is established for each variable group in the second category and that each sub-model structure is used as a variable to be combined with a variable in the first category. Alternatively, risk assessment models may be established for some variable groups in the second category(for example, when there are three weak variable groups, risk assessment sub-models are established for only two of them), and variables in the selected weak variable groups are combined with some variables in the first category. A person skilled in the art shall make no restrictive interpretation thereon.

For better understanding of the technical solution of this embodiment of the present disclosure, the following describes an entire modeling process of a risk scorecard with reference to the accompanying drawings. As shown in FIG. 2, FIG. 2 shows a process of constructing a model by using a conventional model method such as a logistic regression method. As shown in FIG. 3, FIG. 3 shows a process of constructing a model by using the risk assessment method in this embodiment of the present disclosure. It can be learned from FIG. 2 and FIG. 3 that, two processes of “variable grouping” and “modeling (or sub-modeling) a weak variable group” are added to the modeling process in this embodiment of the present disclosure.

In practice, the inventor of the present disclosure tests and compares results of three methods which are a logistic regression method, an expert scorecard method, and the method in the present disclosure. Comparison results are shown in Table 4.

TABLE 4
Comparison between test results

| | | | | Method for |
|---|---|---|---|---|
| | | | | modeling |
| | | Logistic | | a weak |
| | | regression | Expert | variable |
| Method | | method | scorecard | group |
| Selected variable | | 18 | 30 | 30 |
| Model | Development | 32 | 25 | 33 |
| development | sample | | | |
| effect (KS) | Test sample | 30 | 24 | 31 |
| | Inter-temporal test | 31 | 24 | 32 |

| | | | |
|---|---|---|---|
| Model implementation | 26 | 22 | 27 |
| effect (KS) | | | |

KS is one of the most frequently used metrics for measuring a model. The effect of a model during implementation is a final criterion for assessing the model. Table 4 shows that both the model training effect and the implementation effect of the method in this embodiment of the present disclosure are slightly better than those of the logistic regression method, and much better than those of the expert scorecard.

It can be understood that the foregoing solution in this embodiment of the present disclosure may be specifically implemented in, for example, a computer device.

It can be learned from the foregoing that in some feasible implementations of the present disclosure, the risk assessment method is provided. The solution is used in which the variables are grouped and classified, to obtain the strong variable group and the weak variable group; the risk assessment sub-model is constructed for each obtained weak variable group; the sub-model result of each weak variable group is used as a variable to be combined with the variables from the obtained strong variable group, to form the combination variable group; and finally, the comprehensive risk assessment model is constructed for the combination variable group. The following technical effects are obtained:

The method fully digs and uses the data value of a weak variable group, and contribution from each variable in each weak variable group may be reflected in a finally constructed comprehensive model by using a corresponding sub-model result variable, so that a model result of the comprehensive model can reflect a function of each variable in each weak variable group. Therefore, considerations of risk assessment are more comprehensive, the interpretability and the model stability are stronger, and the model result is as objective as possible and is more robust in application, thereby helping improve the effect of risk assessment and helping reflect the future trend of service development.

### Embodiment 2

To better implement the foregoing solution in the embodiment of the present disclosure, the following further provides a related apparatus used for cooperatively implementing the foregoing solution.

Referring to FIG. 4, this embodiment of the present disclosure provides a risk assessment system 400. The risk assessment system 400 may include:

a preprocessing module 410, configured to perform variable categorization according to correlation of data sources of the variables with a target variable, to obtain at least one variable group in a first category and at least one variable group in a second category;

a first construction module 420, configured to construct a risk sub-assessment model for the at least one variable group in the second category, to obtain a sub-model result of the risk assessment model for the at least one variable group in the second category;

a variable combination module 430, configured to: use the sub-model result of the at least one variable group in the second category as a variable, and combine this variable with a variable in the first category, to form a third-type variable group; and

a second construction module 440, configured to construct a comprehensive risk assessment model for the third-type variable group.

In some embodiments, the variable grouping according to data sources is performed according to correlations between the data sources and a target variable and/or correlations between the data sources and user information.

In some embodiments, the preprocessing module 410 includes:

a grouping unit 4101, configured to group all variables into a plurality of variable groups according to different data sources;

a calculation unit 4102, configured to: calculate a correlation coefficient of any variable and a target variable according to correlations between the data sources and the target variable, and calculate average correlation coefficients of the plurality of variable groups;

a determining unit 4103, configured to determine importance values of the plurality of variable groups according to correlations between the data sources and user information; and

a classification unit 4104, configured to: perform variable classification according to the average correlation coefficients and/or the importance values of the plurality of variable groups, classify a variable group whose average correlation coefficient is greater than a threshold and/or whose importance value is the highest as a strong variable group, that is, the variable group in the first category, and classify other variable groups as weak variable groups, that is, variable groups in the second category.

In some embodiments, the variable combination module 430 is specifically configured to: denote a sub-model result of a risk assessment model for any variable group Xⱼ in the at least one variable group in the second category as Log oddsⱼ, use Log oddsⱼ as a variable, denote any variable in the at least one variable group in the first category as xᵢ, and combine all Log oddsⱼ and xᵢ to form the third-type variable group, both i and j being positive integers.

In some embodiments, the second construction module 440 is specifically configured to construct the following comprehensive risk assessment model for the third-type variable group:

$$Logodds = {a}_{0} + {\sum }_{i = 1}^{n} {a}_{i} {x}_{i} + {\sum }_{j = 1}^{m} {a}_{j} {Logodds}_{j}$$

n being the number of variables xᵢ, m being the number of variables Log oddsⱼ, a₀ being an intercept term/a constant term, aᵢ representing a weight of the variable xᵢ, and aⱼ representing a weight of the variable Log oddsⱼ.

In some embodiments, the system 400 further includes a calculation module 450, configured to calculate a probability parameter Probability according to a model result Log odds of the second logic model:

Probability=exp(Log odds)/(1+exp(Log odds))

Probability representing a probability that the model result is impaired.

It can be understood that functions of various functional modules of the system in this embodiment of the present disclosure may be specifically implemented according to the method in the foregoing method embodiment, and for a specific implementation process thereof, refer to the related descriptions in the foregoing method embodiment. Details are not described herein again.

It can be learned from the foregoing that in some feasible implementations of the present disclosure, the risk assessment system is provided. The solution is used in which the variables are grouped and classified, to obtain the strong variable group and the weak variable group; the risk assessment model is constructed for each obtained weak variable group; the model result of each weak variable group is used as a variable to be combined with the obtained strong variable group, to form the combination variable group; and finally, the comprehensive risk assessment model is constructed for the combination variable group. The following technical effects are obtained:

The method fully digs and uses the data value of a weak variable group, and each variable in each weak variable group may be reflected in a finally constructed comprehensive model by using a corresponding model result variable, so that a model result of the comprehensive model can reflect a function of each variable in each weak variable group. Therefore, considerations of risk assessment are more comprehensive, the interpretability and the model stability are stronger, and the model result is as objective as possible and is more robust in application, thereby helping improve the effect of risk assessment and helping reflect the future trend of service development.

### Embodiment 3

This embodiment of the present disclosure further provides a computer storage medium. The computer storage medium may store a program. When being executed by a computer device including a processor, the program enables the computer device to perform some or all steps in the risk assessment method in the foregoing method embodiment.

### Embodiment 4

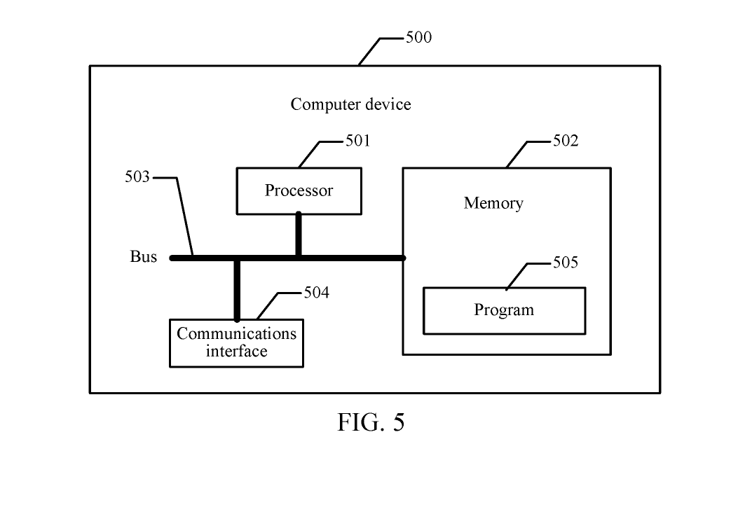

Referring to FIG. 5, this embodiment of the present disclosure further provides a computer device 500.

The computer device 500 includes a processor 501, a memory 502, a bus 503, and a communications interface 504. The memory 502 is configured to store a program 505. The program 505 includes a computer executable instruction. The processor 501 and the memory 502 are connected by using the bus 503. When the computer device 500 runs, the processor 501 executes the program 505 stored in the memory 502, so that the computer device 500 performs the risk assessment method in the foregoing method embodiment.

Specifically, the communications interface 504 may receive data. The received data includes all variables. The memory 502 may store the received variables. The processor 501 may perform the following steps by executing the program 505: performing variable categorization according to data sources, to obtain at least one variable group in the first category and at least one variable group in the second category; constructing a risk assessment sub-model for the at least one variable group in the second category, to obtain a sub-model result of the risk assessment model for the at least one variable group in the second category; using the sub-model result of the at least one variable group in the second category as a variable, and combining the variable with a variable (for example, all variables) in the first category, to form a third-type variable group; and constructing a comprehensive risk assessment model for the third-type variable group.

The bus 503 may be an Industry Standard Architecture (ISA) bus, a peripheral component interconnect (PCI) bus, an Extended Industry Standard Architecture (EISA) bus, or the like. The bus may be classified into one or more of an address bus, a data bus, and a control bus. For convenience of representation, only one bold line is used for representation in FIG. 5, but it does not represent that there is only one bus or one type of bus.

The memory 502 may include a high-speed random access memory (RAM) memory. In some embodiments, the memory 502 may further include a non-volatile memory. For example, the memory 502 may include a magnetic disk memory.

The processor 501 may be a central processing unit (CPU), or the processor 501 may be an application-specific integrated circuit (ASIC), or the processor 501 may be configured as one or more integrated circuits for implementing this embodiment of the present disclosure.

In the foregoing embodiments, descriptions of the embodiments have different emphases, and for parts that are not described in detail in one embodiment, refer to the related descriptions in the other embodiments.

The risk assessment method and system provided in the embodiments of the present disclosure are described above in detail. Although the principles and implementations of the present disclosure are described by using specific examples in this specification, the descriptions of the foregoing embodiments are merely intended to help understand the method and the core idea of the method of the present disclosure. Meanwhile, a person of ordinary skill in the art may make modifications to the specific implementations and application range according to the idea of the present disclosure. In conclusion, the content of this specification should not be construed as a limit on the present disclosure.

What is claimed is:

1. A risk assessment method performed at a computing device having one or more processors and memory storing a plurality of programs to be executed by the one or more processors, the method comprising:
obtaining a plurality of groups of variables from a plurality of variables associated with a user in accordance with data sources of respective variables, wherein the plurality of variables are used for assessing a risk of a target variable associated with the user;
categorizing the plurality of groups of variables into a first category of variable groups and a second category of variable groups in accordance with correlations between respective groups of variables and the target variable, wherein each group of variables in the first category of variable groups has a higher correlation than each group of variables in the second category of variable groups;
obtaining a plurality of risk assessment sub-models for respective groups of variables in the second category of variable groups, wherein a risk assessment sub-model for a respective group of variables is associated with correlation coefficients of the respective variables in the respective group;
obtaining a plurality of sub-model results for the respective risk assessment sub-models in the second category of variable groups, wherein each sub-model result is a sub-model variable; and
obtaining a comprehensive risk assessment model for evaluating the risk of the target variable based on (1) a plurality of variables in the first category of variable groups and (2) the plurality of sub-model variables in the second category of variable groups.

2. The risk assessment method according to claim 1, wherein the plurality of groups of variables are categorized based on correlations between data sources of respective groups of variables and target variable, and correlations between the data sources of respective groups of variables and user information relevant to the target variable.

3. The risk assessment method according to claim 2, wherein categorizing the plurality of groups of variables comprises:
calculating correlation coefficients of respective variables based on correlations between the data sources of the respective variables and the target variable;
calculating average correlation coefficients for respective groups of variables based on the correlation coefficients of the variables from the respective groups of variables;
determining importance values of respective groups of variables according to correlations between the data sources of the variables within the respective groups of variables and user information; and
categorizing the plurality of groups of variables according to the average correlation coefficients and the importance values of the plurality of groups of variable, wherein the plurality of groups of variables in the first category of variable groups have respective average correlation coefficients that are greater than a predetermined first threshold and respective importance values that are higher than a predetermined second threshold, and wherein the plurality of groups of variables in the second category of variable groups have respective average correlation coefficients that are less than or equal to the predetermined first threshold and respective importance values that are lower than or equal to the predetermined second threshold.

4. The risk assessment method according to claim 1, further comprising:
designating a respective sub-model variable of the plurality of sub-model variables as Log oddsⱼ, wherein the respective sub-model variable Log oddsⱼ corresponds to a group of variables Xⱼ in the second category of variable groups; and
designating a respective variable from the first category of variable groups as xᵢ; and
obtaining the comprehensive risk assessment model based on a third category of variables comprising all Log oddsⱼ and xᵢ, both i and j being positive integers.

5. The risk assessment method according to claim 4, wherein the comprehensive risk assessment model comprises:
$$Logodds = {a}_{0} + {\sum }_{i = 1}^{n} {a}_{i} {x}_{i} + {\sum }_{j = 1}^{m} {a}_{j} {Logodds}_{j} ,$$
and wherein n is a total number of variables xᵢ in the first category of variable groups, m is a total number of sub-model variables Log oddsⱼ obtained from the second category of variable groups, a₀ is an intercept term which is a constant term, aᵢ represents a weight of the respective variable xᵢ, and aⱼ represents a weight of the respective sub-model variable Log oddsⱼ.

6. The risk assessment method according to claim 7, further comprising:
calculating a probability parameter Probability according to a result of the comprehensive risk assessment model Log odds by:
Probability=exp(Log odds)/(1+exp(Log odds)),
wherein Probability represents a probability that the result of the comprehensive risk assessment model is impaired.

7. A risk assessment computing device having one or more processors, and memory storing a plurality of programs, wherein the plurality of programs, when executed by the one or more processors, cause the risk assessment computing device to perform the following operations:
obtaining a plurality of groups of variables from a plurality of variables associated with a user in accordance with data sources of respective variables, wherein the plurality of variables are used for assessing a risk of a target variable associated with the user;
categorizing the plurality of groups of variables into a first category of variable groups and a second category of variable groups in accordance with correlations between respective groups of variables and the target variable, wherein each group of variables in the first category of variable groups has a higher correlation than each group of variables in the second category of variable groups;
obtaining a plurality of risk assessment sub-models for respective groups of variables in the second category of variable groups, wherein a risk assessment sub-model for a respective group of variables is associated with correlation coefficients of the respective variables in the respective group;
obtaining a plurality of sub-model results for the respective risk assessment sub-models in the second category of variable groups, wherein each sub-model result is a sub-model variable; and
obtaining a comprehensive risk assessment model for evaluating the risk of the target variable based on (1) a plurality of variables in the first category of variable groups and (2) the plurality of sub-model variables in the second category of variable groups.

8. The risk assessment computing device according to claim 7, wherein the plurality of groups of variables are categorized based on correlations between data sources of respective groups of variables and target variable, and correlations between the data sources of respective groups of variables and user information relevant to the target variable.

9. The risk assessment computing device according to claim 8, wherein categorizing the plurality of groups of variables comprises:
calculating correlation coefficients of respective variables based on correlations between the data sources of the respective variables and the target variable;
calculating average correlation coefficients for respective groups of variables based on the correlation coefficients of the variables from the respective groups of variables;
determining importance values of respective groups of variables according to correlations between the data sources of the variables within the respective groups of variables and user information; and
categorizing the plurality of groups of variables according to the average correlation coefficients and the importance values of the plurality of groups of variable, wherein the plurality of groups of variables in the first category of variable groups have respective average correlation coefficients that are greater than a predetermined first threshold and respective importance values that are higher than a predetermined second threshold, and wherein the plurality of groups of variables in the second category of variable groups have respective average correlation coefficients that are less than or equal to the predetermined first threshold and respective importance values that are lower than or equal to the predetermined second threshold.

10. The risk assessment computing device according to claim 7, wherein the operations further comprise:
designating a respective sub-model variable of the plurality of sub-model variables as Log oddsⱼ, wherein the respective sub-model variable Log oddsⱼ corresponds to a group of variables Xⱼ in the second category of variable groups;
designating a respective variable from the first category of variable groups as xᵢ; and
obtaining the comprehensive risk assessment model based on a third category of variables comprising all Log oddsⱼ and xᵢ, both i and j being positive integers.

11. The risk assessment computing device according to claim 10, wherein the comprehensive risk assessment model comprises:
$$Logodds = {a}_{0} + {\sum }_{i = 1}^{n} {a}_{i} {x}_{i} + {\sum }_{j = 1}^{m} {a}_{j} {Logodds}_{j}$$
and wherein n is a total number of variables xᵢ in the first category of variable groups, m is a total number of sub-model variables Log oddsⱼ obtained from the second category of variable groups, a₀ is an intercept term which is a constant term, aᵢ represents a weight of the respective variable xᵢ, and aⱼ represents a weight of the respective sub-model variable Log oddsⱼ.

12. The risk assessment computing device according to claim 11, wherein the operations further comprise:
calculating a probability parameter Probability according to a result of the comprehensive risk assessment model Log odds by:
Probability=exp(Log odds)/(1+exp(Log odds)),
wherein Probability represents a probability that the result of the comprehensive risk assessment model is impaired.

13. A non-transitory computer readable storage medium storing a plurality of programs in connection with a risk assessment computing device having one or more processors, wherein the plurality of programs, when executed by the one or more processors, cause the risk assessment computing device to perform the following operations:
obtaining a plurality of groups of variables from a plurality of variables associated with a user in accordance with data sources of respective variables, wherein the plurality of variables are used for assessing a risk of a target variable associated with the user;
categorizing the plurality of groups of variables into a first category of variable groups and a second category of variable groups in accordance with correlations between respective groups of variables and the target variable, wherein each group of variables in the first category of variable groups has a higher correlation than each group of variables in the second category of variable groups;
obtaining a plurality of risk assessment sub-models for respective groups of variables in the second category of variable groups, wherein a risk assessment sub-model for a respective group of variables is associated with correlation coefficients of the respective variables in the respective group;
obtaining a plurality of sub-model results for the respective risk assessment sub-models in the second category of variable groups, wherein each sub-model result is a sub-model variable; and
obtaining a comprehensive risk assessment model for evaluating the risk of the target variable based on (1) a plurality of variables in the first category of variable groups and (2) the plurality of sub-model variables in the second category of variable groups.

14. The non-transitory computer readable storage medium according to claim 13, wherein the plurality of groups of variables are categorized based on correlations between data sources of respective groups of variables and target variable, and correlations between the data sources of respective groups of variables and user information relevant to the target variable.

15. The non-transitory computer readable storage medium according to claim 14, wherein categorizing the plurality of groups of variables comprises:
calculating correlation coefficients of respective variables based on correlations between the data sources of the respective variables and the target variable;
calculating average correlation coefficients for respective groups of variables based on the correlation coefficients of the variables from the respective groups of variables;
determining importance values of respective groups of variables according to correlations between the data sources of the variables within the respective groups of variables and user information; and
categorizing the plurality of groups of variables according to the average correlation coefficients and the importance values of the plurality of groups of variable, wherein the plurality of groups of variables in the first category of variable groups have respective average correlation coefficients that are greater than a predetermined first threshold and respective importance values that are higher than a predetermined second threshold, and wherein the plurality of groups of variables in the second category of variable groups have respective average correlation coefficients that are less than or equal to the predetermined first threshold and respective importance values that are lower than or equal to the predetermined second threshold.

16. The non-transitory computer readable storage medium according to claim 13, wherein the operations further comprise:
designating a respective sub-model variable of the plurality of sub-model variables as Log oddsⱼ, wherein the respective sub-model variable Log oddsⱼ corresponds to a group of variables Xⱼ in the second category of variable groups; and
designating a respective variable from the first category of variable groups as xᵢ; and
obtaining the comprehensive risk assessment model based on a third category of variables comprising all Log oddsⱼ and xᵢ, both i and j being positive integers.

17. The non-transitory computer readable storage medium according to claim 16, wherein the comprehensive risk assessment model comprises:
$$Logodds = {a}_{0} + {\sum }_{i = 1}^{n} {a}_{i} {x}_{i} + {\sum }_{j = 1}^{m} {a}_{j} {Logodds}_{j} ,$$
and wherein n is a total number of variables xᵢ in the first category of variable groups, m is a total number of sub-model variables Log oddsⱼ obtained from the second category of variable groups, a₀ is an intercept term which is a constant term, aᵢ represents a weight of the respective variable Xᵢ, and aⱼ represents a weight of the respective sub-model variable Log oddsⱼ.

18. The non-transitory computer readable storage medium according to claim 17, further comprising:
calculating a probability parameter Probability according to a result of the comprehensive risk assessment model Log odds by:
Probability=exp(Log odds)/(1+exp(Log odds)),
wherein Probability represents a probability that the result of the comprehensive risk assessment model is impaired.
